(19) United States
(12) Patent Application Publication
(10) Pub. No.: US 2023/0299255 A1
(43) Pub. Date: Sep. 21, 2023

(54) ELECTRODE FOR BATTERY, MANUFACTURING METHOD THEREOF, AND BATTERY

(71) Applicant: MURATA MANUFACTURING CO., LTD., Kyoto (JP)

(72) Inventors: Hironobu KOBAYASHI, Kyoto (JP); Sachio AKAHIRA, Kyoto (JP)

(21) Appl. No.: 18/201,327

(22) Filed: May 24, 2023

Related U.S. Application Data
(63) Continuation of application No. PCT/JP2022/001932, filed on Jan. 20, 2022.

(30) Foreign Application Priority Data
Feb. 17, 2021 (JP) 2021-023410

(51) Int. Cl. H01M 4/04; H01M 10/0525; H01M 4/139

(52) U.S. Cl. CPC H01M 4/04; H01M 4/139; H01M 10/0525

(57) ABSTRACT

An electrode for a battery includes an electrode body and an electrode tab. The electrode body includes a current collector and an active material layer provided on the current collector. The electrode tab is coupled to the current collector and extends in a first direction. The electrode body includes a first curved end part, a first noncurved end part, a second curved end part, and a second noncurved end part. The first curved end part has a convex shape and is disposed on a back side relative to the electrode tab in a second direction intersecting with the first direction. The first noncurved end part is coupled to the first curved end part and forms a first corner part at a coupling portion to the first curved end part. The first corner part has a convex shape toward the back side. The second curved end part has a convex shape and is disposed on a front side relative to the electrode tab in the second direction. The second noncurved end part is coupled to the second curved end part and forms a second corner part at a coupling portion to the second curved end part. The second corner part has a convex shape toward the front side. A curvature radius of the first curved end part and a curvature radius of the second curved end part are different from each other. An angle of the first corner part and an angle of the second corner part are each an obtuse angle.

### CROSS REFERENCE TO RELATED APPLICATIONS

The present application is a continuation of PCT patent application no. PCT/JP2022/001932, filed on Jan. 20, 2022, which claims priority to Japanese patent application no. JP2021-023410, filed on Feb. 17, 2021, the entire contents of which are incorporated herein by reference.

### BACKGROUND

The present technology relates to an electrode for a battery, a manufacturing method thereof, and a battery.

A battery includes an electrode for a battery, and an electrolytic solution. A configuration of the battery including the electrode for a battery and a manufacturing method thereof have been considered in various ways.

Specifically, in order to obtain batteries having various designs without restriction in shape of a corner, the corner is shaped into a substantially rounded shape. The corner includes a convexly rounded part and a concavely rounded part that are coupled to each other. In order to manufacture a battery having such a corner, an electrode precursor to which multiple electrode tabs are coupled is formed, following which the electrode precursor is cut.

In addition, in order to prevent falling off of an electrode, the electrode is provided with a beveled part. The beveled part has a curvilinear part and outer peripheral connection parts each coupled to the curvilinear part, and the beveled part has an obtuse angle. The angle of the beveled part is an angle defined by a tangent line at an intersection point between the curvilinear part and the outer peripheral connection part and a straight line along the outer peripheral connection part.

### SUMMARY

The present technology relates to an electrode for a battery, a manufacturing method thereof, and a battery.

Although consideration has been given in various ways regarding a configuration of an electrode for a battery and a manufacturing method thereof, safety and manufacturing efficiency of a battery including the electrode for an electrode are not sufficient yet. Accordingly, there is room for improvement in terms thereof.

It is therefore desirable to provide an electrode for a battery, a manufacturing method thereof, and a battery each of which makes it possible to achieve superior safety and superior manufacturing efficiency.

An electrode for a battery according to an embodiment of the present technology includes an electrode body and an electrode tab. The electrode body includes a current collector and an active material layer provided on the current collector. The electrode tab is coupled to the current collector and extends in a first direction. The electrode body includes a first curved end part, a first noncurved end part, a second curved end part, and a second noncurved end part. The first curved end part has a convex shape and is disposed on a back side relative to the electrode tab in a second direction intersecting with the first direction. The first noncurved end part is coupled to the first curved end part and forms a first corner part at a coupling portion to the first curved end part. The first corner part has a convex shape toward the back side. The second curved end part has a convex shape and is disposed on a front side relative to the electrode tab in the second direction. The second noncurved end part is coupled to the second curved end part and forms a second corner part at a coupling portion to the second curved end part. The second corner part has a convex shape toward the front side. A curvature radius of the first curved end part and a curvature radius of the second curved end part are different from each other. An angle of the first corner part and an angle of the second corner part are each an obtuse angle.

A manufacturing method of an electrode for a battery according to an embodiment of the present technology includes: preparing an electrode precursor including an electrode plate and multiple electrode tabs coupled to the electrode plate, the multiple electrode tabs each extending in a first direction and being coupled to the electrode plate with being separated from each other in a second direction intersecting with the first direction; cutting the electrode plate within a region including one of the electrode tabs of the electrode precursor at a position on a back side relative to the one electrode tab in the second direction by means of a first cutting blade; and thereafter cutting the electrode plate cut by means of the first cutting blade at a position on a front side relative to the one electrode tab in the second direction by means of a second cutting blade. The electrode plate includes a current collector to which the multiple electrode tabs are coupled, and an active material layer provided on the current collector. The first cutting blade includes a first curved blade part curved into a convex shape toward the back side, and a noncurved blade part coupled to the first curved blade part and forming a blade corner part at a coupling portion to the first curved blade part. The blade corner part has a convex shape toward the back side. The second cutting blade includes a second curved blade part at a position corresponding to the first curved blade part in the second direction. The second curved blade part is curved into a convex shape toward the front side. A curvature radius of the second curved blade part is greater than a curvature radius of the first curved blade part. An angle of the blade corner part is an obtuse angle. When the electrode plate is cut by means of the second cutting blade, the second cutting blade is aligned with respect to the electrode precursor to cause the second curved blade part to overlap a portion of the electrode plate cut by means of the noncurved blade part of the first cutting blade.

A battery according to an embodiment of the present technology includes an electrode for a battery and an electrolytic solution. The electrode for a battery has a configuration similar to the configuration of the electrode for a battery of the embodiment of the present technology described above.

According to the electrode for a battery of an embodiment, the electrode for a battery includes the electrode body and the electrode tab. The electrode body includes the first curved end part, the first noncurved end part, the first corner part, the second curved end part, the second noncurved end part, and the second corner part. The curvature radius of the first curved end part and the curvature radius of the second curved end part are different from each other. The angle of the first corner part and the angle of the second corner part are each an obtuse angle. It is therefore possible to achieve superior safety and superior manufacturing efficiency.

According to the manufacturing method of the electrode for a battery of an embodiment, the electrode plate is cut within the region including one of the electrode ends of the electrode precursor that includes the electrode plate and the multiple electrode tabs by means of the first cutting blade that includes the first curved blade part, the noncurved blade part, and the blade corner part. Thereafter, the electrode plate cut by means of the first cutting blade is cut by means of the second cutting blade that includes the second curved blade part. The curvature radius of the second curved blade part is greater than the curvature radius of the first curved blade part. The angle of the blade corner part is an obtuse angle. When the electrode plate is cut by means of the second cutting blade, the second cutting blade is aligned with respect to the electrode precursor to cause the second curved blade part to overlap a portion of the electrode plate cut by means of the noncurved blade part. It is therefore possible to achieve superior safety and superior manufacturing efficiency.

According to the battery of an embodiment, the electrode for a battery having the above-described configuration is included. It is therefore possible to obtain a battery having superior safety and superior manufacturing efficiency.

Note that effects of the present technology are not necessarily limited to those described herein and may include any of a series of suitable effects in relation to the present technology.

### BRIEF DESCRIPTION OF THE FIGURES

FIG. 1 is a plan view of a configuration of an electrode according to an embodiment of the present technology.

FIG. 2 is a sectional view of the configuration of the electrode illustrated in FIG. 1.

FIG. 3 is a plan view for describing a manufacturing method of the electrode according to an embodiment of the present technology.

FIG. 4 is a plan view for describing the manufacturing method of the electrode following FIG. 3.

FIG. 5 is a plan view for describing the manufacturing method of the electrode following FIG. 4.

FIG. 6 is a plan view for describing the manufacturing method of the electrode following FIG. 5.

FIG. 7 is a plan view for describing the manufacturing method of the electrode following FIG. 6.

FIG. 8 is a perspective view of a configuration of a battery according to an embodiment of the present technology.

FIG. 9 is a sectional view of a configuration of a battery device illustrated in FIG. 8.

FIG. 10 is a plan view of a configuration of a positive electrode illustrated in FIG. 9.

FIG. 11 is a sectional view of a configuration of a negative electrode illustrated in FIG. 9.

FIG. 12 is a plan view of a configuration of an electrode of an embodiment.

FIG. 13 is a plan view for describing a manufacturing method of the electrode of an embodiment.

FIG. 14 is a block diagram of a configuration of an application example of the battery.

### DETAILED DESCRIPTION

One or more embodiments of the present technology are described below in further detail including with reference to the drawings.

A description is given first of an electrode for a battery according to an embodiment of the present technology. Note that a manufacturing method of an electrode for a battery according to an embodiment of the present technology is a method of manufacturing the electrode for a battery described here, and is thus described together below.

The electrode for a battery (hereinafter simply referred to as an “electrode”) is to be used in an electrochemical device. In this case, the electrode may be used as a positive electrode, may be used as a negative electrode, or may be used as each of a positive electrode and a negative electrode.

A battery including the electrode may be a primary battery or a secondary battery. However, applications of the electrode are not limited to batteries, and the electrode may be included in another electrochemical device such as a capacitor.

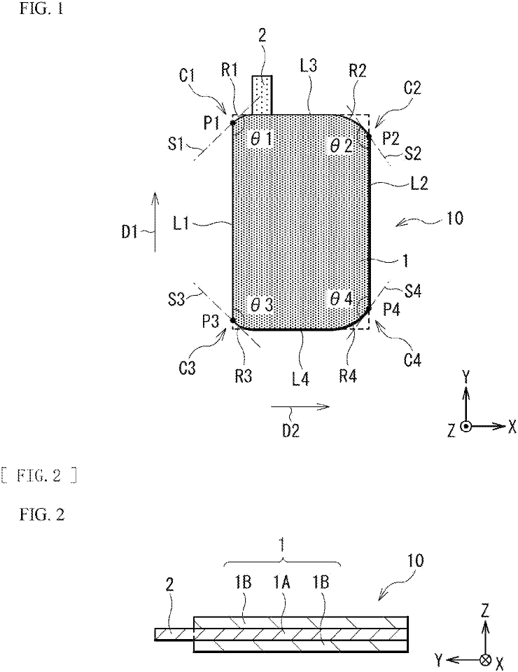

FIG. 1 illustrates a planar configuration of an electrode 10, which is the electrode according to an embodiment of the present technology, and FIG. 2 illustrates a sectional configuration of the electrode 10 illustrated in FIG. 1.

In the following description, for convenience, upper, lower, right, and left sides of FIG. 1 correspond to upper, lower, right, and left sides of the electrode 10, respectively.

The electrode 10 includes, as illustrated in FIGS. 1 and 2, an electrode body 1 and an electrode tab 2. Note that, in FIG. 1, the electrode body 1 is densely shaded, while the electrode tab 2 is slightly shaded.

Directions D1 and D2 illustrated in FIG. 1 indicate two respective directions to be used to describe the configuration of the electrode 10. The direction D1 is an extending direction (a first direction) of the electrode tab 2, which is a direction toward the upper side of FIG. 1, as to be described later. The direction D2 is a direction (a second direction) intersecting with the direction D1, which is a direction toward the right side of FIG. 1, as to be described later. Here, the direction D1 is a direction along a Y-axis, and the direction D2 is a direction perpendicular to the Y-axis, that is, a direction along an X-axis.

The electrode body 1 is a main part of the electrode 10 that causes an electrode reaction to proceed. The electrode body 1 has a characteristic shape (planar shape) to improve safety and manufacturing efficiency of a battery including the electrode 10. The shape of the electrode body 1 will be described in detail later.

Specifically, the electrode body 1 includes a current collector 1A and an active material layer 1B. The active material layer 1B is provided on the current collector 1A.

The current collector 1A is an electrically conductive support that supports the active material layer 1B. The current collector 1A has two opposed surfaces on each of which the active material layer 1B is provided. The current collector 1A includes one or more of electrically conductive materials including, without limitation, a metal material.

The active material layer 1B is provided on the current collector 1A. Here, the active material layer 1B is provided on each of the two opposed surfaces of the current collector 1A, and the electrode 10 thus includes two active material layers 1B. However, the active material layer 1B may be provided only on one of the two opposed surfaces of the current collector 1A, and the electrode 10 may thus include only one active material layer 1B.

The active material layer 1B may include one or more of active materials. Note that the active material layer 1B may further include one or more of other materials including, without limitation, a binder and a conductor. The active material is not particularly limited in kind. Specifically, the kind of the active material is determined based on the application of the electrode 10, that is, a condition as to, for example, whether the electrode 10 is to be used as the positive electrode or the negative electrode. Specific kinds of the active material appropriate for applications of the electrode 10 will be described later.

The binder includes one or more of materials including, without limitation, a synthetic rubber and a polymer compound. Examples of the synthetic rubber include a styrene-butadiene-based rubber, a fluorine-based rubber, and ethylene propylene diene. Examples of the polymer compound include polyvinylidene difluoride, polyimide, and carboxymethyl cellulose.

The conductor includes one or more of electrically conductive materials including, without limitation, a carbon material. Examples of the carbon material include graphite, carbon black, acetylene black, and Ketjen black. Note that the electrically conductive material may be, for example, a metal material or a polymer compound.

A method of forming the active material layer 1B is not particularly limited, and specifically includes one or more of methods including, without limitation, a coating method, a vapor-phase method, a liquid-phase method, a thermal spraying method, and a firing (sintering) method.

The electrode tab 2 is coupled to the current collector 1A of the electrode body 1. The electrode tab 2 extends in the direction D1.

As apparent from FIG. 1, the direction D1 is a direction from a side (a lower side) where the electrode tab 2 is coupled to the electrode body 1 toward a side (an upper side) away from the electrode body 1. Accordingly, the electrode tab 2 is coupled to the electrode body 1 so as to project from the electrode body 1 toward the direction D1.

A material included in the electrode tab 2 is not particularly limited, and is specifically similar to the material included in the current collector 1A. Note that the material included in the electrode tab 2 and the material included in the current collector 1A may be identical to each other, or may be different from each other.

Here, the electrode tab 2 is a portion (a projecting portion) of the current collector 1A and is thus integrated with the current collector 1A. In FIG. 2, a boundary between the electrode body 1 and the electrode tab 2 is indicated by a broken line for easy discrimination between the electrode body 1 and the electrode tab 2.

Alternatively, the electrode tab 2 may be physically separated from the current collector 1A and may be thus a component separated from the current collector 1A. In this case, the electrode tab 2 may be coupled to the current collector 1A by a method such as a welding method.

Now, a planar shape of the electrode body 1 is specifically described in specific with reference to FIG. 1. The planar shape of the electrode body 1 is a planar shape along an XY plane.

Here, the planar shape of the electrode body 1 is substantially rectangular. That is, the electrode body 1 includes four linear end parts L1 to L4, and the planar shape of the electrode body 1 is thus mainly defined by the four linear end parts L1 to L4. Specifically, the planar shape of the electrode body 1 is a substantially oblong shape having a greater dimension in the direction D1 than in the direction D2.

Hereinafter, being disposed to a back side (a left side) relative to the electrode tab 2 in the direction D2 is described as being “on a back side relative to the electrode tab 2” or simply “on a back side”, and being disposed on a front side (a right side) relative to the electrode tab 2 in the direction D2 is described as being “on a front side relative to the electrode 2” or simply “on a front side”.

The linear end part L1 is a first noncurved end part disposed on the back side relative to the electrode tab 2. Here, the linear end part L1 extends in the direction D1. The linear end part L2 is a second noncurved end part disposed on the front side relative to the electrode tab 2, and extends in the direction D1. Accordingly, the linear end parts L1 and L2 are opposed to each other in the direction D2.

The linear end part L3 is disposed on a side closer to the electrode tab 2 than the linear end part L4 is, and extends in the direction D2. The linear end part L4 is disposed on a side more away from the electrode tab 2 than the linear end part L3 is, and extends in the direction D2. Accordingly, the linear end parts L3 and L4 are opposed to each other in the direction D1. Here, the electrode tab 2 is coupled to the current collector 1A of the electrode body 1 at the linear end part L3, and is placed closer to the linear end part L1 than the linear end part L2.

The electrode body 1 includes respective curved end parts R1 to R4 at four corners. That is, the substantially rectangular (substantially oblong) planar shape of the electrode body 1 is defined by the four linear end parts L1 to L4 and the four curved end parts R1 to R4.

The curved end part R1 is a first curved end part having a convex shape and disposed on the back side relative to the electrode tab 2. The curved end part R1 has a curvature radius V1. The curved end part R1 is coupled to each of the linear end parts L1 and L3.

A corner part C1 (a first corner part) is provided in a convex shape toward the back side relative to the electrode tab 2 at a coupling portion of the linear end part L1 to the curved end part R1. The corner part C1 is a corner part having a vertex at the coupling portion (coupling point P1) between the curved end part R1 and the linear end part L1. The corner part C1 has an angle θ1. The angle θ1 is an angle defined by a straight line along the linear end part L1 and a tangent line S1 tangent to the curved end part R1 at the coupling point P1. The angle θ1 is an obtuse angle (an angle greater than 90°).

The curved end part R2 is a second curved end part having a convex shape and disposed on the front side relative to the electrode tab 2. The curved end part R2 has a curvature radius V2. The curved end part R2 is coupled to each of the linear end parts L2 and L3.

A corner part C2 (a second corner part) is provided in a convex shape toward the front side relative to the electrode tab 2 at a coupling portion of the linear end part L2 to the curved end part R2. The corner part C2 is a corner part having a vertex at the coupling portion (coupling point P2) between the curved end part R2 and the linear end part L2. The corner part C2 has an angle θ2. The angle θ2 is an angle defined by a straight line along the linear end part L2 and a tangent line S2 tangent to the curved end part R2 at the coupling point P2. The angle θ2 is an obtuse angle.

That is, the phrase “on the back side relative to the electrode tab 2 (in the direction D2)” regarding the curved end part R1 refers to a position on the left side relative to the electrode tab 2, more specifically, a position on the left side relative to the electrode tab 2 on the side close to the electrode tab 2 rather than the side away from the electrode tab 2 in a case where the electrode 10 is placed such that the electrode tab 2 is disposed on the upper side as illustrated in FIG. 1.

In contrast, the phrase “on the front side relative to the electrode tab 2 (in the direction D2)” regarding the curved end part R2 refers to a position on the right side relative to the electrode tab 2, more specifically, a position on the right side relative to the electrode tab 2 on the side close to the electrode tab 2 rather than the side away from the electrode tab 2 in the case where the electrode 10 is placed such that the electrode tab 2 is disposed on the upper side as illustrated in FIG. 1.

A reason why the electrode body 1 includes the curved end parts R1 and R2 and the corner parts C1 and C2 is that an occurrence of a short circuit in the battery including the electrode 10 is suppressed, and an occurrence of manufacturing loss of the electrode 10 is suppressed, thus improving each of safety and manufacturing efficiency. The reason described here will be described in detail later.

Note that the curvature radius V1 of the curved end part R1 and the curvature radius V2 of the curved end part R2 are different from each other. In this case, the curvature radius V1 may be greater than the curvature radius V2, or the curvature radius V1 may be less than the curvature radius V2.

A reason why the curvature radii V1 and V2 are different from each other is that the occurrence of manufacturing loss of the electrode 10 is further suppressed, thus further improving manufacturing efficiency of the battery. The reason described here will be described in detail later.

Here, as illustrated in FIG. 1, the curvature radius V2 of the curved end part R2 disposed on the front side relative to the electrode tab 2 is greater than the curvature radius V1 of the curved end part R1 disposed on the back side relative to the electrode tab 2. Respective values of the curvature radii V1 and V2 are not particularly limited as long as the magnitude relationship described here is satisfied between the curvature radii V1 and V2.

In one example, the curvature radius V1 is within a range from 0.5 mm to 2.5 mm both inclusive, and the curvature radius V2 is within a range from 1.0 mm to 5.0 mm both inclusive. A reason for this is that a difference between the curvature radii V1 and V2 becomes sufficiently large, thus sufficiently suppressing the occurrence of a short circuit and sufficiently suppressing the occurrence of manufacturing loss of the electrode 10.

Here, configurations of the curved end parts R3 and R4 are similar to the configurations of the curved end parts R1 and R2 described above, respectively.

The curved end part R3 is a third curved end part having a convex shape and disposed on the back side relative to the electrode tab 2. The curved end part R3 has a curvature radius V3. The curved end part R3 is coupled to each of the linear end parts L1 and L4.

A corner part C3 (a third corner part) is provided in a convex shape toward the back side relative to the electrode tab 2 at a coupling portion of the linear end part L1 to the curved end part R3. The corner part C3 is a corner part having a vertex at the coupling portion (coupling point P3) between the curved end part R3 and the linear end part L1. The corner part C3 has an angle θ3. The angle θ3 is an angle defined by a straight line along the linear end part L1 and a tangent line S3 tangent to the curved end part R3 at the coupling point P3. The angle θ3 is an obtuse angle.

The curved end part R4 is a fourth curved end part having a convex shape and disposed on the front side relative to the electrode tab 2. The curved end part R4 has a curvature radius V4. The curved end part R4 is coupled to each of the linear end parts L2 and L4.

A corner part C4 (a fourth corner part) is provided in a convex shape toward the front side relative to the electrode tab 2 at a coupling portion of the linear end part L2 to the curved end part R4. The corner part C4 is a corner part having a vertex at the coupling portion (coupling point P4) between the curved end part R4 and the linear end part L2. The corner part C4 has an angle θ4. The angle θ4 is an angle defined by a straight line along the linear end part L2 and a tangent line S4 tangent to the curved end part R4 at the coupling point P4. The angle θ4 is an obtuse angle.

That is, the phrase “on a back side relative to the electrode tab 2 (in the direction D2)” regarding the curved end part R3 refers to a position on the left side relative the electrode tab 2, more specifically, a position on the left side relative to the electrode tab 2 on the side away from the electrode tab 2 rather than the side close to the electrode tab 2 in the case where the electrode 10 is placed such that the electrode tab 2 is disposed on the upper side as illustrated in FIG. 1.

In contrast, the phrase “on the front side relative to the electrode tab 2 (in the direction D2)” regarding the curved end part R4 refers to a position on the right side relative to the electrode tab 2, more specifically, a position on the right side relative to the electrode tab 2 on the side away from the electrode tab 2 rather than the side close to the electrode tab 2 in the case where the electrode 10 is placed such that the electrode tab 2 is disposed on the upper side as illustrated in FIG. 1.

A reason why the electrode body 1 includes the curved end parts R3 and R4 and the corner parts C3 and C4 is that safety and manufacturing efficiency of the battery are each improved as in the case where the electrode body 1 includes the curved end parts R1 and R2 and the corner parts C1 and C2.

Note that the curvature radius V3 of the curved end part R3 and the curvature radius V4 of the curved end part R4 are different from each other. In this case, the curvature radius V3 may be greater than the curvature radius V4, or the curvature radius V3 may be less than the curvature radius V4. A reason why the curvature radii V3 and V4 are different from each other is that manufacturing efficiency of the battery is further improved as in the case where the curvature radii V1 and V2 are different from each other.

Here, as illustrated in FIG. 1, the curvature radius V4 of the curved end part R4 disposed on the front side relative to the electrode tab 2 is greater than the curvature radius V3 of the curved end part R3 disposed on the back side relative to the electrode tab 2. Respective values of the curvature radii V3 and V4 are not particularly limited as long as the magnitude relationship described here is satisfied between the curvature radii V3 and V4. In one example, a range of the curvature radius V3 is similar to the range of the curvature radius V1 described above, and a range of the curvature radius V4 is similar to the range of the curvature radius V3 described above.

Note that the curvature radius V3 may be the same as the curvature radius V1, or may be different from the curvature radius V1. Likewise, the curvature radius V4 may be the same as the curvature radius V2, or may be different from the curvature radius V2.

Accordingly, the planar shape of the electrode body 1 is a substantially rectangular (substantially quadrangular) shape including the respective curved end parts R1 to R4 at the four corners. Note that, in FIG. 1, for an easy comparison with a case where the electrode body 1 includes no curved end parts R1 to R4, that is, a case where the electrode body 1 has a rectangular (oblong) planar shape including respective corner parts at the four corners, an outer edge of the electrode body 1 having the oblong planar shape is indicated by a broken line.

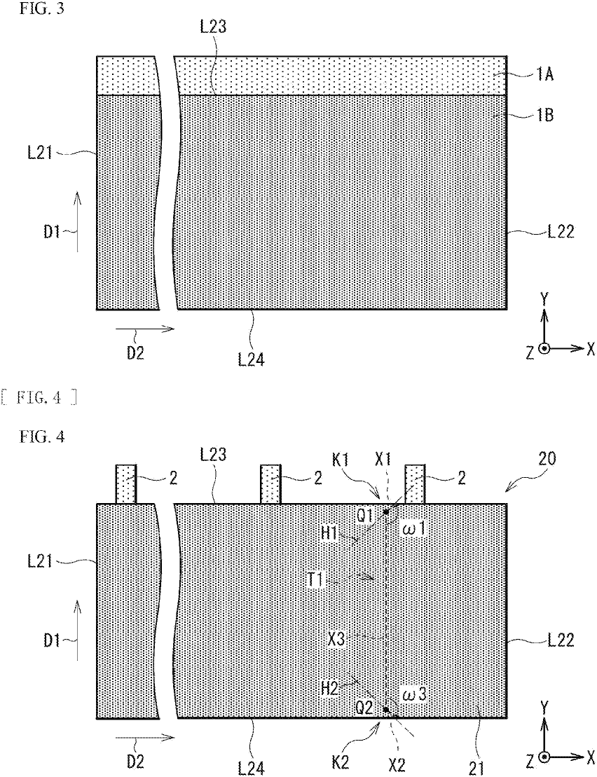

FIGS. 3 to 7 each illustrate a planar configuration corresponding to FIG. 1 to describe a manufacturing method of the electrode 10. In the following description, reference is made, where appropriate, to FIGS. 1 and 2 that have been described above as well as FIGS. 3 to 7.

In a case of manufacturing the electrode 10, as described below, a precursor (an electrode precursor 20) for manufacturing the electrode 10 is used, and two cutting blades T1 and T2 are used to process (perform cutting processes of) the electrode precursor 20. A configuration of each of the electrode precursor 20 and the cutting blades T1 and T2 will be described later.

In the following, a description is given of a case where the cutting processes are continuously performed using the electrode precursor 20 and the cutting blades T1 and T2 to thereby manufacture multiple electrodes 10 in a continuous manner. In the manufacturing process of the electrode 10, a forming process of the electrode precursor 20, a pre-cutting process of the electrode precursor 20, a first cutting process of the electrode precursor 20 using the cutting blade T1, and a second cutting process of the electrode precursor 20 using the cutting blade T2 are performed in this order, as described below.

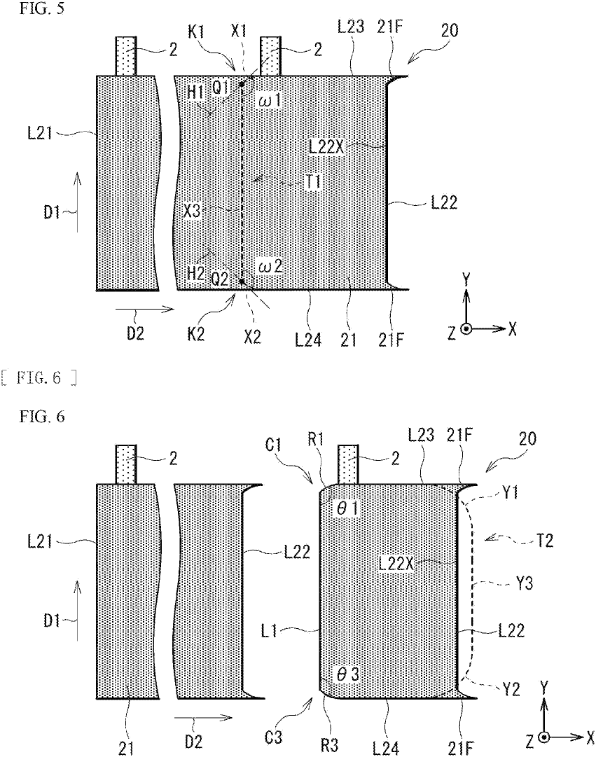

First, as illustrated in FIGS. 3 and 4, the electrode precursor 20 is formed.

In a case of forming the electrode precursor 20, first, a mixed material (mixture) in which materials including, without limitation, an active material, a binder, and a conductor are mixed with each other is put into a solvent, to thereby prepare a paste mixture slurry. The solvent may be an aqueous solvent or a non-aqueous solvent (an organic solvent).

Thereafter, as illustrated in FIG. 3, the mixture slurry is continuously applied on each of the two opposed surfaces of the current collector 1A to thereby form the active material layer 1B. Here, the current collector 1A has a band shape extending in the direction D2, and the active material layer 1B is thus formed into a band shape extending in the direction D2. In this case, a dimension of the current collector 1A in the direction D1 is made greater than a dimension of the active material layer 1B in the direction D1, to thereby cause a portion of the current collector 1A to project toward the upper side from the active material layer 1B. Thereafter, the active material layer 1B is compression-molded by means of, for example, a roll pressing machine on an as-needed basis. In this case, the active material layer 1B may be heated, or the compression-molding process of the active material layer 1B may be repeated multiple times. In this manner, the active material layer 1B is formed on each of the two opposed surfaces of the current collector 1A. As a result, an electrode plate 21 is formed.

Lastly, the portion of the current collector 1A projecting toward the upper side from the active material layer 1B is cut by means of a cutting blade (not illustrated) for forming multiple electrode tabs 2, to thereby form multiple electrode tabs 2 as illustrated in FIG. 4. In this case, the multiple electrode tabs 2 each extend in the direction D1 and are arranged with being separated from each other in the direction D2. In this manner, the active material layer 1B is formed on each of the two opposed surfaces of the current collector 1A, forming the electrode plate 21. In addition, the multiple electrode tabs 2 are coupled to the current collector 1A of the electrode plate 21, forming the electrode precursor 20 that includes the electrode plate 21 and the multiple electrode tabs 2.

Here, the electrode plate 21 (the current collector 1A and the active material layers 1B) of the electrode precursor 20 has an oblong planar shape having a greater dimension in the direction D2 than in direction D1 and defined by linear end parts L21 to L24. The linear end parts L21 and L22 correspond to the linear end parts L1 and L2, respectively, and thus extend in the direction D1. The linear end parts L23 and L24 correspond to the linear end parts L3 and L4, respectively, and thus extend in the direction D2.

Thereafter, as illustrated in FIGS. 4 and 5, the pre-cutting process of the electrode precursor 20 is performed by means of a cutting apparatus provided with the cutting blade T1 (first cutting blade). The pre-cutting process is a preprocess to form the electrode 10 using the electrode precursor 20. Note that, in FIG. 4, a portion of the electrode precursor 20 to be cut by means of the cutting blade T1 is indicated by a broken line to describe a configuration (shape) of the cutting blade T1.

The cutting blade T1 has a shape corresponding to a planar shape of the electrode 10 (the curved end part R1, the linear end part L1, and the corner part C1). That is, the cutting blade T1 includes a curved blade part X1 corresponding to the curved end part R1, and a linear blade part X3 corresponding to the linear end part L1. Here, the linear blade part X3 is a non-curvilinear blade part extending in the direction D1.

The curved blade part X1 is a first curved blade part curved into a convex shape toward the back side relative to the electrode tab 2. The curved blade part X1 has a curvature radius W1. The curved blade part X1 is coupled to the linear blade part X3. The curvature radius W1 of the curved blade part X1 is similar to the curvature radius V1 of the curved end part R1.

A blade corner part K1 is provided in a convex shape toward the back side relative to the electrode tab 2 at a coupling portion of the linear blade part X3 to the curved blade part X1. The blade corner part K1 corresponds to the corner part C1, and is thus a corner part having a vertex at the coupling portion (coupling point Q1) between the curved blade part X1 and the linear blade part X3. The blade corner part K1 has an angle ω1. The angle ω1 is an angle defined by a straight line along the linear blade part X3 and a blade tangent line H1 tangent to the curved blade part X1 at the coupling point Q1. Like the angle θ1 of the angle C1, the angle ω1 is an obtuse angle.

Here, the cutting blade T1 has the shape corresponding to the planar shape of the electrode 10 (the curved end parts R1 and R3, the linear end part L1, and the corner parts C1 and C3). Thus, the cutting blade T1 includes a curved blade part X2 corresponding to the curved end part R3 together with the curved blade part X1 and the linear blade part X3 described above.

The curved blade part X2 is a second curved blade part curved into a convex shape toward the back side relative to the electrode tab 2. The curved blade part X2 has a curvature radius W2. The curved blade part X2 is coupled to the linear blade part X3. The curvature radius W2 of the curved blade part X2 is similar to the curvature radius V3 of the curved end part R3.

A blade corner part K2 is provided in a convex shape toward the back side relative to the electrode tab 2 at a coupling portion of the linear blade part X3 to the curved blade part X2. The blade corner part K2 corresponds to the corner part C3, and is thus a corner part having a vertex at the coupling portion (coupling point Q2) between the curved blade part X2 and the linear blade part X3. The blade corner part K2 has an angle ω2. The angle ω2 is an angle defined by a straight line along the linear blade part X3 and a blade tangent line H2 tangent to the curved blade part X2 at the coupling point Q2. Like the angle θ3 of the angle C3, the angle ω2 is an obtuse angle.

In the pre-cutting process of the electrode precursor 20 using the cutting blade T1, as illustrated in FIG. 4, the electrode plate 21 is cut within a region including one electrode tab 2, more specifically, one of the multiple electrode tabs 2 disposed on the most front side, by means of the cutting blade T1 (the curved blade parts X1 and X2 and the linear blade part X3).

Accordingly, as illustrated in FIG. 5, the portion of the electrode precursor 20 including the one electrode tab 2 is removed from the electrode precursor 20 after the cutting. In this case, a fresh linear end part L22 is formed at a portion of the electrode plate 21 cut by means of the cutting blade T1, and two protrusions 21F are formed at respective portions of the electrode plate 21 cut by means of the curved blade parts X1 and X2. The linear end part L22 has a cut part L22X which is a portion at which the electrode plate 21 has been cut by means of the linear blade part X3. The cut part L22X extends in the direction D1. Note that, in FIG. 5, illustration of the removed portion of the electrode precursor 20 is omitted.

Thereafter, as illustrated in FIGS. 5 and 6, the first cutting process of the electrode precursor 20 is performed by means of the cutting apparatus provided with the cutting blade T1 again. The first cutting process is a cutting process to form a portion (the curved end parts R1 and R3, the linear end part L1, and the corner parts C1 and C3) of the electrode 10 using the electrode precursor 20. The configuration of the cutting blade T1 is as described above. Note that, in FIG. 5, a portion of the electrode precursor 20 to be cut by means of the cutting blade T1 is indicated by a broken line.

In the first cutting process of the electrode precursor 20 using the cutting blade T1, as illustrated in FIG. 5, the electrode plate 21 is cut within a region including one of the electrode tabs 2 disposed on the most front side, that is, at a position on the back side relative to the one electrode tab 2, by means of the cutting blade T1 (the curved blade parts X1 and X2, and the linear blade part X3).

Accordingly, as illustrated in FIG. 6, the portion of the electrode precursor 20 including the one electrode tab 2 is separated from the electrode precursor 20 after the cutting. In this case, the curved end parts R1 and R3 and the corner parts C1 and C3 are formed at respective portions of the electrode plate 21 cut by means of the curved blade parts X1 and X2, and the linear end part L1 is formed at a portion of the electrode plate 21 cut by means of the linear blade part X3.

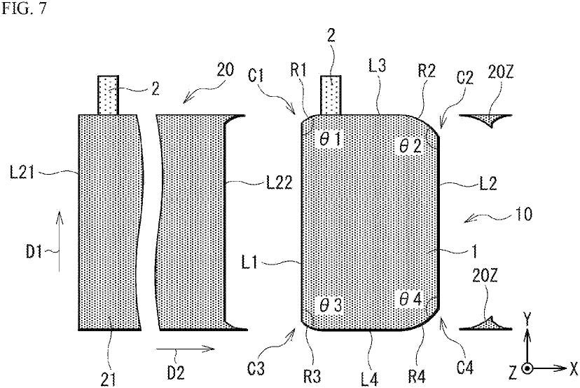

Lastly, as illustrated in FIGS. 6 and 7, the second cutting process of the electrode precursor 20 is performed by means of a cutting apparatus provided with the cutting blade T2 (second cutting blade). The second cutting process is a cutting process to form the remaining portions (the curved end parts R2 and R4, the linear end parts L2 to L4, and the corner parts C2 and C4) of the electrode 10 using the electrode precursor 20. Note that, in FIG. 6, a portion of the electrode precursor 20 to be cut by means of the cutting blade T2 is indicated by a broken line to specify a configuration (shape) of the cutting blade T2.

The cutting blade T2 has a shape corresponding to the planar shape of the electrode 10 (the curved end part R2). That is, the cutting blade T2 includes a curved blade part Y1 corresponding to the curved end part R2 at a position corresponding to the curved blade part X1 in the direction D2. More specifically, the cutting blade T2 includes a linear blade part Y3 together with the curved blade part Y1 described above. Here, the linear blade part Y3 extends in the direction D1.

The curved blade part Y1 is a second curved blade part curved into a convex shape toward the front side relative to the electrode tab 2. The curved blade part Y1 has a curvature radius W3. The curved blade part Y1 is coupled to the linear blade part Y3. The curvature radius W3 of the curved blade part Y1 is similar to the curvature radius V2 of the curved end part R2. That is, the curvature radius W3 of the curved blade part Y1 is greater than the curvature radius W1 of the curved blade part X1.

Note that the curved blade part Y1 may have a blade corner part provided in a convex shape toward the front side relative to the electrode tab 2 at a coupling portion to the linear blade part Y3, or may have no blade corner part. In FIG. 6, illustration is given of a case where no blade corner part is provided at the coupling portion between the curved blade part Y1 and the linear blade part Y3.

Here, the cutting blade T2 has the shape corresponding to the planar shape of the electrode 10 (the curved end parts R2 and R4). Thus, the cutting blade T2 includes a curved blade part Y2 corresponding to the curved end part R4 together with the curved blade part Y1 and the linear blade part Y3 described above.

The curved blade part Y2 is curved into a convex shape toward the front side relative to the electrode tab 2. The curved blade part Y2 has a curvature radius W4. The curved blade part Y2 is coupled to the linear blade part Y3. The curvature radius W4 of the curved blade part Y2 is similar to the curvature radius V4 of the curved end part R4. That is, the curvature radius W4 of the curved blade part Y2 is greater than the curvature radius W2 of the curved blade part X2.

Note that the curved blade part Y2 may have a blade corner part provided in a convex shape toward the front side relative to the electrode tab 2 at a coupling portion to the linear blade part Y3, or may have no blade corner part. In FIG. 6, illustration is given of a case where no blade corner part is provided at the coupling portion between the curved blade part Y2 and the linear blade part Y3.

Alternatively, the cutting blade T2 may not include the linear blade part Y3 and may include only the curved blade parts Y1 and Y2.

In the second cutting process of the electrode precursor 20 using the cutting blade T2, as illustrated in FIG. 6, the electrode plate 21 is cut by means of the cutting blade T2 (the curved blade parts Y1 and Y2, and the linear blade part Y3) at a position on the front side relative to the electrode tab 2 of the electrode precursor 20 cut by means of the cutting blade T1 in the first cutting process.

In this case, the cutting blade T2 is aligned with respect to the electrode precursor 20 such that the curved blade part Y1 overlaps the portion (cut part L22X) of the electrode plate 21 cut by means of the linear blade part X3 of the cutting blade T1. Further, the cutting blade T2 is aligned with respect to the electrode precursor 20 such that the curved blade part Y2 overlaps the cut part L22X.

Accordingly, as illustrated in FIG. 7, two excess parts 20Z are removed from the electrode precursor 20 after the cutting. In this case, the curved end parts R2 and R4 and the corner parts C2 and C4 are formed at respective portions of the electrode plate 21 cut by means of the curved blade parts Y1 and Y2, and the linear end parts L2 to L4 are formed by the use of the linear end parts L22 and L24.

The two excess parts 20Z are parts to be discarded without being used to form the electrode 10. As apparent from FIG. 7, the two excess parts 20Z each have a substantially triangular planar shape. Thus, the excess part 20Z has a significantly smaller dimension in the direction D 1 than the dimension of the electrode plate 21 in the direction D1. Accordingly, the two excess parts 20Z each have sufficiently small area. This sufficiently reduces an amount of loss (an amount of waste) of the electrode precursor 20 not to be used to manufacture the electrode 10 even though the electrode precursor 20 is cut in the direction D2 to manufacture the electrode 10.

Accordingly, as illustrated in FIG. 1, the electrode body 1 including the curved end parts R1 to R4 and the corner parts C1 to C4 is formed. As a result, the electrode 10 that includes the electrode tab 2 together with the electrode body 1 is completed.

Thereafter, multiple electrodes 10 are continuously manufactured using the electrode precursor 20 by repeating the procedure illustrated in FIGS. 5 to 7, that is, the procedure in which the first cutting process of the electrode plate 21 is performed within the region including one electrode tab 2, following which the second cutting process is performed.

According to the electrode 10, action and effects described below are obtainable.

The electrode 10 includes the electrode body 1 (the current collector 1A and the active material layers 1B) and the electrode tab 2, and the electrode body 1 includes the curved end parts R1 and R2, the linear end parts L1 and L2, and the corner parts C1 and C2. In addition, the curvature radius V1 of the curved end part R1 and the curvature radius V2 of the curved end part R2 are different from each other, and the angle θ1 of the corner part C1 and the angle θ2 of the corner part C2 are each an obtuse angle.

In this case, first, the electrode body 1 includes the curved end part R1, which suppresses the occurrence of a short circuit in the battery including the electrode 10 as compared with a case where the electrode body 1 includes a corner part instead of the curved part R1.

In detail, in a battery in which the electrode 10 is opposed to another electrode (a counter electrode) with a separator interposed therebetween, if the electrode body 1 includes a corner part, the corner part easily sticks into the separator, for example, due to vibrations or pressure, causing the electrode body 1 to easily break through the separator. This causes the electrode body 1 to be easily exposed unintentionally, causing a short circuit to easily occur due to contact between the electrode body 1 and the other electrode. More specifically, in a case where a positive electrode which is the electrode 10 is opposed to a negative electrode with a separator interposed therebetween, the positive electrode easily comes into contact with the negative electrode unintentionally, causing a short circuit to easily occur.

In contrast, in the case where the electrode body 1 includes the curved end part R1, the curved end part R1 is prevented from easily sticking into the separator, preventing the electrode body 1 from easily breaking through the separator. This helps to prevent the electrode body 1 from being easily exposed, suppressing the occurrence of a short circuit. That is, even if the positive electrode which is the electrode 10 is opposed to the negative electrode with the separator interposed therebetween, the positive electrode is prevented from easily coming into contact with the negative electrode, suppressing the occurrence of a short circuit.

The advantages described here in terms of the curved end part R1 are similarly obtainable also in terms of the curved end part R2. That is, in the case where the electrode body 1 includes the curved end part R2, the electrode body 1 is prevented from easily breaking through the separator, suppressing the occurrence of a short circuit.

Second, although the electrode body 1 includes the corner part C1, the angle θ1 of the corner part C1 is an obtuse angle. This suppresses the occurrence of a short circuit as compared with a case where the angle θ1 is an acute angle.

In detail, in a case where the angle θ1 is an acute angle, the electrode body 1 easily breaks through the separator, for example, due to vibrations and pressure, causing a short circuit to easily occur, as described above.

In contrast, in a case where the corner part θ is an obtuse angle, the electrode body 1 is prevented from easily breaking through the separator even if the electrode body 1 includes the corner part C1, suppressing the occurrence of a short circuit.

The advantages described here in terms of the corner part C1 are similarly obtainable also in terms of the corner part C2. That is, in a case where the angle θ2 of the corner part C2 is an obtuse angle, the electrode body 1 is prevented from easily breaking through the separator, suppressing the occurrence of a short circuit.

Third, the curvature radius V1 of the curved end part R1 and the curvature radius V2 of the curved end part R2 are different from each other. This helps to prevent the battery including the electrode 10 from easily causing performance malfunctions and manufacturing malfunctions, as compared with a case where the curvature radii V1 and V2 are identical to each other.

In detail, in a case where the curvature radii V1 and V2 are identical to each other, when the electrode plate 21 is cut by means of the cutting apparatus provided with the cutting blade in the manufacturing process of the electrode 10 using the electrode precursor 20, malfunctions described below easily occur depending on accuracy in aligning the cutting blade with respect to the electrode plate 21.

Here, the configuration of the cutting blade T2 is similar to the configuration of the cutting blade T1, and the curvature radius W1 of the curved blade part X1 and the curvature radius W3 of the curved blade part Y1 are thus assumed to be identical to each other. In this case, if the position of the cutting blade T2 is shifted frontward from a desired position in the second cutting process using the cutting blade T2, the curved blade part Y1 is hindered from overlapping the linear end part L22X. This causes the corner part C2 to project into a burr shape, making the angle θ2 of the corner part C2 an acute angle. The electrode body 1 (the corner part C1) thus easily breaks through the separator, causing a short circuit to easily occur.

If the position of the cutting blade T2 is shifted backward from the desired position in the second cutting process using the cutting blade T2, the electrode plate 21 is unintentionally cut by means of the linear blade part Y3, increasing the area of the excess part 20Z. In this case, the dimension of the excess part 20Z in the direction D1 is the same as the dimension of the electrode body 1 in the direction D1, significantly increasing the area of the excess part 20Z. This increases the area of the portion of the electrode precursor 20 not to be used to manufacture the electrode 10, increasing the amount of manufacturing loss (the amount of waste) of the electrode precursor 20. As a result, the manufacturing loss of the electrode 10 easily occurs.

Accordingly, in a case where the curvature radii V1 and V2 are identical to each other, a trade-off problem is generated that suppressing the occurrence of a short circuit increases the manufacturing loss of the electrode 10, whereas suppressing the occurrence of the manufacturing loss of the electrode 10 causes a short circuit to easily occur.

In contrast, in a case where the curvature radii V1 and V2 are different from each other, the battery including the electrode 10 is prevented from easily causing performance malfunctions and manufacturing malfunctions regardless of the accuracy in aligning the cutting blade with respect to the electrode precursor 20.

In detail, if the position of the cutting blade T2 is shifted forward from the desired position in the second cutting process using the cutting blade T2, the cutting blade T2 is aligned with respect to the electrode precursor 20 such that the curved blade part Y1 overlaps the linear end part L22X, making the angle θ2 of the corner part C2 an obtuse angle. This helps to prevent the electrode body 1 (the corner part C1) from easily breaking through the separator, suppressing the occurrence of a short circuit.

Even if the position of the cutting blade T2 is shifted backward from the desired position in the second cutting process using the cutting blade T2, the electrode plate 21 is prevented from being easily cut by means of the linear blade part Y3, reducing the area of the excess part 20Z. The area of the portion of the electrode precursor 20 not to be used to manufacture the electrode 10 is thus reduced, reducing the amount of manufacturing loss of the electrode precursor 20. This suppresses the occurrence of manufacturing loss of the electrode 10.

Accordingly, in the case where the curvature radii V1 and V2 are different from each other, the occurrence of a short circuit is suppressed, and the occurrence of manufacturing loss of the electrode 10 is suppressed. This eliminates the trade-off problem described above.

The occurrence of a short circuit in the electrode 10 is thereby suppressed, and the trade-off problem is eliminated. It is therefore possible to achieve superior safety and superior manufacturing efficiency. It is therefore also possible to reduce the manufacturing cost in accordance with the improvement in the manufacturing efficiency.

In particular, the curvature radius V1 of the curved end part R1 may be within the range from 0.5 mm to 2.5 mm both inclusive, and the curvature radius V2 of the curved end part R2 may be within the range from 1.0 mm to 5.0 mm both inclusive. In this case, the difference between the curvature radii V1 and V2 becomes sufficiently large. This sufficiently suppresses the occurrence of a short circuit, and sufficiently eliminates the trade-off problem. It is therefore possible to achieve higher effects.

In addition, the electrode body 1 may further include the curved end parts R3 and R4 and the corner parts C3 and C4. The curvature radius V3 of the curved end part R3 and the curvature radius V4 of the curved end part R4 may be different from each other. The angle θ3 of the corner part C3 and the angle θ4 of the corner part C4 may each be an obtuse angle. The electrode body 1 may thus have a substantially quadrangular planar shape including the respective curved end parts R1 to R4 at the four corners. In this case, similar advantages to those described above in terms of the curved end parts R1 and R2 and the corner parts C1 and C2 are obtainable also in terms of the curved end parts R3 and R4 and the corner parts C3 and C4. Accordingly, safety is further improved, and manufacturing efficiency is further improved. It is therefore possible to achieve higher effects.

According to the manufacturing method of the electrode 10, the electrode plate 21 is cut within the region including one of the electrode tabs 2 of the electrode precursor 20 (the electrode plate 21 and the multiple electrode tabs 2) by means of the cutting blade T1 (the curved blade part X1 and the linear blade part X3), following which the electrode plate 21 cut by means of the cutting blade T1 is further cut by means of the cutting blade T2 (the curved blade part X2). In a case of cutting the electrode plate 21 by means of the cutting blade T2, the curvature radius W3 of the curved blade part Y2 is made greater than the curvature radius W1 of the curved blade part X1, and the cutting blade T2 is aligned with respect to the electrode precursor 20 such that the curved blade part Y2 overlaps the linear end part L22X.

Accordingly, as described above, the electrode 10 including the curved end parts R1 and R2 and the corner parts C1 and C2 is manufactured, where the curvature radius V2 of the curved end part R2 is greater than the curvature radius V1 of the curved end part R1, and the angle θ1 of the corner part C1 and the angle θ2 of the corner part C2 are each an obtuse angle. It is therefore possible to obtain the electrode 10 having superior safety and superior manufacturing efficiency. In this case, the cutting of the electrode plate 21 by means of the cutting blade T1 and the cutting of the electrode plate 21 by means of the cutting blade T2 may be repeated for each region including one electrode tab 2. This makes it possible to continuously form multiple electrodes 10 using the electrode precursor 20. It is therefore possible to achieve higher effects.

A description is given next of a battery including the electrode described above.

The battery to be described here is a secondary battery that obtains a battery capacity using insertion and extraction of an electrode reactant, and includes a positive electrode, a negative electrode, and an electrolytic solution. The electrolytic solution is a liquid electrolyte.

The electrode reactant is not particularly limited in kind, and specific examples thereof include a light metal such as an alkali metal or an alkaline earth metal. Examples of the alkali metal include lithium, sodium, and potassium. Examples of the alkaline earth metal include beryllium, magnesium, and calcium.

An example is given below of a case where the electrode reactant is lithium. A secondary battery that obtains a battery capacity using insertion and extraction of lithium is a so-called lithium-ion secondary battery. In the lithium-ion secondary battery, lithium is inserted and extracted in an ionic state.

In the lithium-ion secondary battery described here, a charge capacity of the negative electrode is greater than a discharge capacity of the positive electrode. In other words, an electrochemical capacity per unit area of the negative electrode is set to be greater than an electrochemical capacity per unit area of the positive electrode. A reason for this is that precipitation of the electrode reactant on a surface of the negative electrode is prevented during charging.

An example is given below of a case where the electrode is used as the positive electrode.

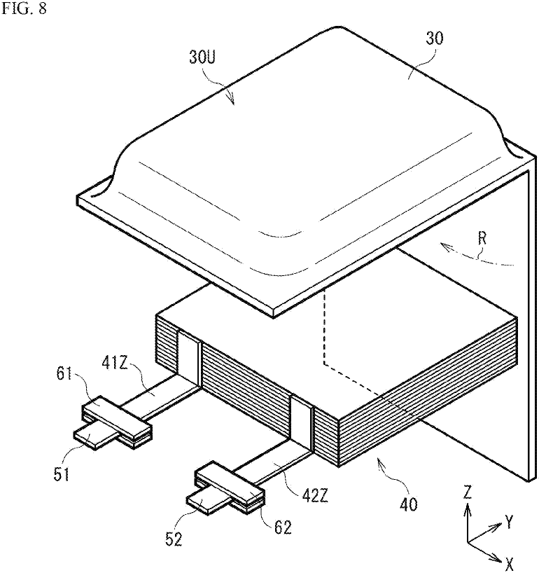

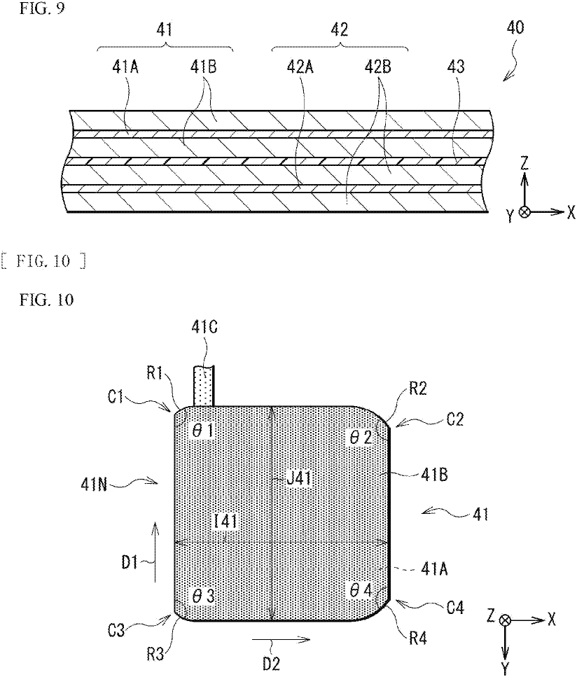

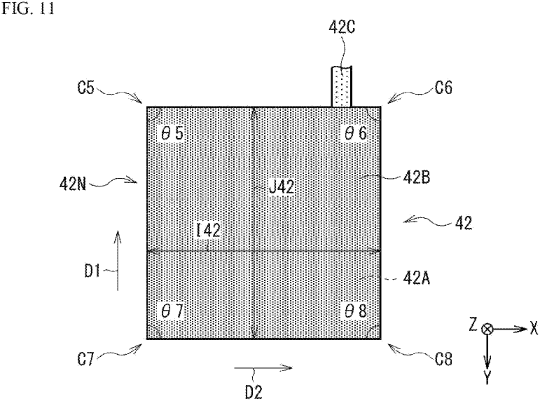

FIG. 8 illustrates a sectional configuration of a secondary battery which is the battery according to the embodiment of the technology. FIG. 9 illustrates a sectional configuration of a battery device 40 illustrated in FIG. 8. FIG. 10 illustrates a planar configuration of a positive electrode 41 illustrated in FIG. 9. FIG. 11 illustrates a planar configuration of a negative electrode 42 illustrated in FIG. 9. Note that FIG. 9 illustrates only a portion of the battery device 40, and that FIGS. 10 and 11 each correspond to FIG. 1.

In the following description, reference is made, where appropriate, to FIGS. 1 and 2 regarding the electrode 10 that has been described above, and to the series of components of the electrode 10.

As illustrated in FIGS. 8 to 11, the secondary battery includes an outer package film 30, the battery device 40, a positive electrode lead 51, a negative electrode lead 52, and sealing films 61 and 62. The secondary battery described here is a secondary battery of a laminated-film type that includes the outer package film 30 having flexibility or softness.

As illustrated in FIG. 8, the outer package film 30 is a flexible outer package member that contains the battery device 40. The outer package film 30 has a pouch-shaped structure in which the battery device 40 is sealed in a state of being contained inside the outer package film 30. The outer package film 30 thus contains the positive electrode 41, the negative electrode 42, and the electrolytic solution to be described later.

Here, the outer package film 30 is a single film-shaped member and is folded in a folding direction R. The outer package film 30 has a depression part 30U to place the battery device 40 therein. The depression part 30U is a so-called deep drawn part.

Specifically, the outer package film 30 is a three-layered laminated film including a fusion-bonding layer, a metal layer, and a surface protective layer that are stacked in this order from an inner side. In a state in which the outer package film 30 is folded, outer edge parts of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 30 is not particularly limited in configuration or the number of layers, and may be single-layered or two-layered, or may include four or more layers.

The sealing film 61 is interposed between the outer package film 30 and the positive electrode lead 51. The sealing film 62 is interposed between the outer package film 30 and the negative electrode lead 52. Note that the sealing film 61, the sealing film 62, or both may be omitted.

The sealing film 61 is a sealing member that prevents entry, for example, of outside air into the outer package film 30. Specifically, the sealing film 61 includes a polymer compound such as a polyolefin that has adherence to the positive electrode lead 51. Examples of the polyolefin include polypropylene.

A configuration of the sealing film 62 is similar to that of the sealing film 61 except that the sealing film 62 is a sealing member that has adherence to the negative electrode lead 52. That is, the sealing film 62 includes a polymer compound such as a polyolefin that has adherence to the negative electrode lead 52.

As illustrated in FIGS. 8 to 11, the battery device 40 is a power generation device that includes the positive electrode 41, the negative electrode 42, a separator 43, and the electrolytic solution (not illustrated). The battery device 40 is contained inside the outer package film 30.

Here, the battery device 40 is a so-called stacked electrode body. That is, in the battery device 40, the positive electrode 41 and the negative electrode 42 are stacked on each other with the separator 43 interposed therebetween. The number of the positive electrodes 41, the number of the negative electrodes 42, and the number of the separators 43 to be stacked are not particularly limited. Here, a plurality of positive electrodes 41 and a plurality of negative electrodes 42 are alternately stacked with the separator 43 interposed therebetween. The positive electrode 41, the negative electrode 42, and the separator 43 are each impregnated with the electrolytic solution.

The positive electrode 41 has a configuration similar to that of the electrode 10 described above. The positive electrode 41 thus has a substantially rectangular planar shape. That is, the positive electrode 41 includes, as illustrated in FIGS. 9 and 10, a positive electrode current collector 41A corresponding to the current collector 1A, a positive electrode active material layer 41B corresponding to the active material layer 1B, and a positive electrode tab 41C corresponding to the electrode tab 2. Note that illustration of the positive electrode tab 41C is omitted in FIG. 9.

The positive electrode current collector 41A has two opposed surfaces on each of which the positive electrode active material layer 41B is provided. The positive electrode current collector 41A includes an electrically conductive material such as a metal material. Examples of the metal material include aluminum.

Here, the positive electrode active material layer 41B is provided on each of the two opposed surfaces of the positive electrode current collector 41A. The positive electrode active material layer 41B includes one or more of positive electrode active materials into which lithium is insertable and from which lithium is extractable. Note that the positive electrode active material layer 41B may be provided only on one of the two opposed surfaces of the positive electrode current collector 41A on a side where the positive electrode 41 is opposed to the negative electrode 42. In addition, the positive electrode active material layer 41B may further include one or more other materials including, without limitation, a positive electrode binder and a positive electrode conductor.

The positive electrode active material is not particularly limited in kind, and specific examples thereof include a lithium-containing compound. The lithium-containing compound is a compound that includes lithium and one or more transition metal elements as constituent elements. The lithium-containing compound may further include one or more other elements as one or more constituent elements. The one or more other elements are not particularly limited in kind as long as the one or more other elements are each an element other than lithium and the transition metal elements. Specifically, the one or more other elements are any one or more elements belonging to groups 2 to 15 in the long period periodic table. The lithium-containing compound is not particularly limited in kind, and is specifically an oxide, a phosphoric acid compound, a silicic acid compound, or a boric acid compound, for example.

Specific examples of the oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Specific examples of the phosphoric acid compound include LiFePO₄, LiMnPO₄, LiFe_{0.5}Mn_{0.5}PO₄, and LiFe_{0.3}Mn_{0.7}PO_{4.}

Details of the positive electrode binder are similar to those of the binder described above. Details of the positive electrode conductor are similar to those of the conductor described above.

A configuration of the positive electrode tab 41C is similar to the configuration of the electrode tab 2. Here, the positive electrode tab 41C is a portion (a projecting portion) of the positive electrode current collector 41A, and is thus integrated with the positive electrode current collector 41A. Multiple positive electrode tabs 41C are joined to each other by a method such as a welding method to thereby form a single joint part 41Z having a lead shape.

Here, the positive electrode current collector 41A and the positive electrode active material layer 41B form a positive electrode body 41N corresponding to the electrode body 1. The positive electrode tab 41C is thus coupled to the positive electrode body 41N, more specifically, coupled to the joint part 41Z.

As illustrated in FIG. 10, the positive electrode body 41N has a planar shape similar to the planar shape of the electrode body 1. That is, the positive electrode body 41N includes the curved end parts R1 to R4 and the corner parts C1 to C4. Here, the planar shape of the positive electrode body 41N is a substantially square shape having a dimension I41 corresponding a dimension in the direction D2 and a dimension J41 corresponding a dimension in the direction D1 that are identical to each other.

The negative electrode 42 has a configuration different from the configuration of the electrode 10 described above. That is, the negative electrode 42 includes, as illustrated in FIGS. 9 and 11, a negative electrode current collector 42A, a negative electrode active material layer 42B, and a negative electrode tab 42C.

The negative electrode current collector 42A has two opposed surfaces on each of which the negative electrode active material layer 42B is provided. The negative electrode current collector 42A includes an electrically conductive material such as a metal material. Examples of the metal material include copper.

Here, the negative electrode active material layer 42B is provided on each of the two opposed surfaces of the negative electrode current collector 42A. The negative electrode active material layer 42B includes one or more of negative electrode active materials into which lithium is insertable and from which lithium is extractable. Note that the negative electrode active material layer 42B may be provided only on one of the two opposed surfaces of the negative electrode current collector 42A on a side where the negative electrode 42 is opposed to the positive electrode 41. In addition, the negative electrode active material layer 42B may further include one or more other materials including, without limitation, a negative electrode binder and a negative electrode conductor. Details of the negative electrode binder are similar to those of the positive electrode binder. Details of the negative electrode conductor are similar to those of the positive electrode conductor.

The negative electrode active material includes, for example, a carbon material, a metal-based material, or both. A reason for this is that a high energy density is obtainable. Examples of the carbon material include graphitizable carbon, non-graphitizable carbon, and graphite (natural graphite and artificial graphite). The metal-based material is a material that includes, as one or more constituent elements, one or more elements among metal elements and metalloid elements that are each able to form an alloy with lithium. Specific examples of the metal elements and the metalloid elements include silicon, tin, or both. Note that the metal-based material may be a simple substance, an alloy, a compound, a mixed material of two or more thereof, or a material including two or more phases thereof. Specific examples of the metal-based material include TiSi₂ and SiOₓ (O < x ≤ 2 or 0.2 < x < 1.4).

The negative electrode tab 42C is provided at a position not overlapping the positive electrode tab 41C. The position of the negative electrode tab 42C is thus shifted from the position of the positive electrode tab 41C in the direction D2. Here, the negative electrode tab 42C is a portion (a projecting portion) of the negative electrode current collector 42A, and is thus integrated with the negative electrode current collector 42A. Multiple negative electrode tabs 42C are joined to each other by a method such as a welding method to thereby form a single joint part 42Z having a lead shape.

Here, the negative electrode current collector 42A and the negative electrode active material layer 42B form a negative electrode body 42N. The negative electrode tab 42C is thus coupled to the negative electrode body 42N, more specifically, coupled to the joint part 42Z.

As illustrated in FIG. 11, the negative electrode body 42N has a rectangular planar shape. Here, the planar shape of the negative electrode body 42N is a square shape having a dimension I42 that corresponds to the dimension I41, and a dimension J42 that corresponds to the dimension J41. The dimension I42 and the dimension J42 are identical to each other. The negative electrode body 42N includes corner parts C5 to C8 each having a convex shape instead of the curved end parts R1 to R4. An angle θ5 of the corner part C5, an angle θ6 of the corner part C6, an angle θ7 of the corner part C7, and an angle θ8 of the corner part C8 are not each particularly limited, and are each specifically 90°.

Note that the dimension I42 is greater than the dimension I41. In other words, the negative electrode 42 projects from the positive electrode 41 at a portion on the front side relative to the electrode tab 42C, and projects from the positive electrode 41 at a portion on the back side relative to the negative electrode tab 42C.

In addition, the dimension J42 is greater than the dimension J41. The negative electrode 42 thus projects toward the upper side from the positive electrode 41 and projects toward the lower side from the positive electrode 41.

Accordingly, the negative electrode 42 is opposed to the entirety of the positive electrode 41. A reason for this is that unintentional precipitation of lithium ions discharged from the positive electrode 41 on a surface of the negative electrode 42 is suppressed.

As illustrated in FIG. 9, the separator 43 is an insulating porous film interposed between the positive electrode 41 and the negative electrode 42, and allows lithium ions to pass therethrough while preventing contact (a short circuit) between the positive electrode 41 and the negative electrode 42. The separator 43 includes a polymer compound such as polyethylene. The separator 43 may be single-layered or multi-layered.

The positive electrode 41, the negative electrode 42, and the separator 43 are each impregnated with the electrolytic solution. The electrolytic solution includes a solvent and an electrolyte salt. The solvent includes one or more of non-aqueous solvents (organic solvents) including, without limitation, a carbonic-acid-ester-based compound, a carboxylic-acid-ester-based compound, and a lactone-based compound. The electrolytic solution including the non-aqueous solvent(s) is a so-called non-aqueous electrolytic solution. The electrolyte salt includes one or more of light metal salts including, without limitation, a lithium salt.

As illustrated in FIG. 8, the positive electrode lead 51 is a positive electrode terminal coupled to the joint part 41Z. The positive electrode lead 51 is led to an outside of the outer package film 30. The positive electrode lead 51 includes an electrically conductive material such as aluminum. The positive electrode lead 51 is not particularly limited in shape, and specifically has a shape such as a thin plate shape or a meshed shape.

As illustrated in FIG. 8, the negative electrode lead 52 is a negative electrode terminal coupled to the joint part 42Z. The negative electrode lead 52 is led to the outside of the outer package film 30. The negative electrode lead 52 includes an electrically conductive material such as copper. Here, the negative electrode lead 52 is led toward a direction similar to that in which the positive electrode lead 51 is led out. Note that details of a shape of the negative electrode lead 52 are similar to those of the shape of the positive electrode lead 51.

Upon charging the secondary battery, in the battery device 40, lithium is extracted from the positive electrode 41, and the extracted lithium is inserted into the negative electrode 42 via the electrolytic solution. Upon discharging the secondary battery, in the battery device 40, lithium is extracted from the negative electrode 42, and the extracted lithium is inserted into the positive electrode 41 via the electrolytic solution. Upon charging and discharging, lithium is inserted and extracted in an ionic state.

In a case of manufacturing the secondary battery, the positive electrode 41 and the negative electrode 42 are each fabricated, and the electrolytic solution is prepared, following which the secondary battery is fabricated using the positive electrode 41, the negative electrode 42, and the electrolytic solution, according to a procedure described below.

The positive electrode 41 is manufactured through a procedure similar to the manufacturing procedure of the electrode 10 described above.

Specifically, first, a mixed material (a positive electrode mixture) in which materials including, without limitation, the positive electrode active material, the positive electrode binder, and the positive electrode conductor are mixed with each other is put into a solvent to thereby prepare a paste positive electrode mixture slurry. Thereafter, the positive electrode mixture slurry is applied on each of the two opposed surfaces of the positive electrode current collector 41A having a band shape, to thereby form the positive electrode active material layer 41B. Thereafter, the positive electrode active material layer 41B may be compression-molded by means of, for example, a roll pressing machine. In this case, the positive electrode active material layer 41B may be heated, or the compression-molding process may be repeated multiple times.

Thereafter, the positive electrode current collector 41A is cut by means of a cutting blade for forming multiple positive electrode tabs 41C, to thereby form multiple positive electrode tabs 41C. The positive electrode active material layer 41B is thereby formed on each of the two opposed surfaces (excluding the multiple positive electrode tabs 41C) of the positive electrode current collector 41A having the band shape to which the multiple positive electrode tabs 41C are coupled. As a result, a positive electrode precursor corresponding to the electrode precursor 20 is formed. Although not specifically illustrated here, the positive electrode precursor includes the positive electrode current collector 41A, the positive electrode active material layers 41B, and the positive electrode tabs 41C that correspond to the electrode body 1 (the current collector 1A and the active material layers 1B) and the electrode tabs 2.

Lastly, cutting processes of the positive electrode precursor (the pre-cutting process, the first cutting process, and the second cutting process) are performed by means of the cutting apparatus (the cutting blades T1 and T2) described above. As a result, the positive electrode 41 including the positive electrode body 41N (the positive electrode current collector 41A and the positive electrode active material layers 41B) and the positive electrode tab 41C is fabricated.

First, a mixed material (a negative electrode mixture) in which materials including, without limitation, the negative electrode active material, the negative electrode binder, and the negative electrode conductor are mixed with each other is put into a solvent to thereby prepare a paste negative electrode mixture slurry. Thereafter, the negative electrode mixture slurry is applied on each of the two opposed surfaces of the negative electrode current collector 42A integrated with the negative electrode tab 42C, to thereby form the negative electrode active material layer 42B. Thereafter, the negative electrode active material layer 42B may be compression-molded. The negative electrode active material layer 42B is thus formed on each of the two opposed surfaces of the negative electrode current collector 42A. As a result, the negative electrode 42 is fabricated.

The electrolyte salt is put into the solvent. The electrolyte salt is thereby dispersed or dissolved in the solvent. As a result, the electrolytic solution is prepared.

First, the positive electrode 41 and the negative electrode 42 are alternately stacked on each other with the separator 43 interposed therebetween to thereby fabricate a stacked body. Although not specifically illustrated here, the stacked body has a configuration similar to the configuration of the battery device 40 except that the positive electrode 41, the negative electrode 42, and the separator 43 are not each impregnated with the electrolytic solution.

Thereafter, the multiple positive electrode tabs 41C are joined to each other by a method such as a welding method to thereby form the joint part 41Z. In addition, the multiple negative electrode tabs 42C are joined to each other by a method such as a welding method to thereby form the joint part 42Z. Thereafter, the positive electrode lead 51 is coupled to the joint part 41Z by a method such as a welding method, and the negative electrode lead 52 is coupled to the joint part 42Z by a method such as a welding method.

Thereafter, the stacked body is placed inside the depression part 30U, following which the outer package film 30 (the fusion-bonding layer/the metal layer/the surface protective layer) is folded to thereby cause parts of the outer package film 30 to be opposed to each other. Thereafter, outer edge parts of two sides of the outer package film 30 (the fusion-bonding layer) opposed to each other are bonded to each other by a method such as a thermal-fusion-bonding method to thereby place the stacked body in the outer package film 30 having the pouch shape.

Lastly, the electrolytic solution is injected into the outer package film 30 having the pouch shape, following which the outer edge parts of the remaining one side of the outer package film 30 (the fusion-bonding layer) are bonded to each other by a method such as a thermal-fusion-bonding method. In this case, the sealing film 61 is interposed between the outer package film 30 and the positive electrode lead 51, and the sealing film 62 is interposed between the outer package film 30 and the negative electrode lead 52. The stacked body is thereby impregnated with the electrolytic solution. Thus, the battery device 40 which is the stacked electrode body is fabricated, and the battery device 40 is sealed in the outer package film 30 having the pouch shape. As a result, the secondary battery is assembled.

The assembled secondary battery is charged and discharged. Various conditions including, without limitation, an environment temperature, the number of times of charging and discharging (the number of cycles), and charging and discharging conditions may be set as desired. A film is thereby formed on a surface of each of the positive electrode 41 and the negative electrode 42. This allows the secondary battery to be in an electrochemically stable state. As a result, the secondary battery is completed.

According to the secondary battery, the positive electrode 41 has the configuration similar to the configuration of the electrode described above. Accordingly, the occurrence of a short circuit is suppressed, and the trade-off problem is eliminated for a reason similar to that described in terms of the electrode. It is therefore possible to achieve superior safety and superior manufacturing efficiency.

In particular, the secondary battery may include a lithium-ion secondary battery that includes the positive electrode 41 and the negative electrode 42, and the electrode described above may include the positive electrode 41. In this case, a sufficient battery capacity is stably obtainable using insertion and extraction of lithium. It is therefore possible to achieve higher effects.

Further, the negative electrode 42 may be opposed to the entirety of the positive electrode 41, and the negative electrode 42 may include the corner parts C5 and C6 at the respective positions corresponding to the curved end parts R1 and R2. This suppresses unintentional precipitation of lithium ions discharged from the positive electrode 41 on the surface of the negative electrode 42. Accordingly, safety is further improved, and it is therefore possible to achieve higher effects. In this case, the negative electrode 42 may further include the corner parts C7 and C8 at the respective positions corresponding to the curved end parts R3 and R4. This further suppresses precipitation of lithium ions. It is therefore possible to achieve further higher safety.

Other action and effects of the secondary battery are similar to those of the electrode described above.

The configuration of the secondary battery described herein is suitably modifiable including as described below. Note that any two or more of the following series of modifications may be combined with each other.

In the electrode 10 illustrated in FIG. 1, the curvature radius V1 of the curved end part R1 and the curvature radius V2 of the curved end part R2 are different from each other, and the curvature radius V3 of the curved end part R3 and the curvature radius V4 of the curved end part R4 are different from each other.

However, the curvature radii V1 and V2 may be different from each other whereas the curvature radii V3 and V4 may be identical to each other. Alternatively, the curvature radii V1 and V2 may be identical to each other whereas the curvature radii V3 and V4 may be different from each other.

In these cases also, the occurrence of a short circuit is suppressed, and the trade-off problem is eliminated, as compared with a case where the curvature radii V1 and V2 are identical to each other and where the curvature radii V3 and V4 are identical to each other. Similar effects are therefore obtainable.

The planar shape of the electrode 10 illustrated in FIG. 1 is the substantially rectangular shape including the respective curved end parts R1 to R4 at the four corners.

However, the planar shape of the electrode 10 is not particularly limited as long as the planar shape of the electrode 10 includes the curved end parts R1 and R2, and the curvature radii V1 and V2 are different from each other. In one example, the planar shape of the electrode 10 may be a substantially triangular shape, a substantially pentagonal shape, or another substantially polygonal shape.

In this case also, the occurrence of a short circuit is suppressed, and the trade-off problem is eliminated, as compared with the case where the planar shape of the electrode 10 includes no curved end parts R1 and R2 and the case where the curvature radii V1 and V2 are identical to each other. Similar effects are therefore obtainable.

As a matter of course, the planar shape of the electrode 10 is not particularly limited as long as the planar shape of the electrode 10 includes the curved end parts R3 and R4, and the curvature radii V3 and V4 are different from each other. The planar shape of the electrode 10 may thus be a substantially triangular shape, a substantially pentagonal shape, or another substantially polygonal shape. In this case also, similar effects are obtainable.

In the electrode 10 illustrated in FIG. 1, no corner part is provided at the coupling portion of the linear end part L3 to the curved end part R1, and no corner part having a convex shape is provided at the coupling portion of the linear end part L3 to the curved end part R2.

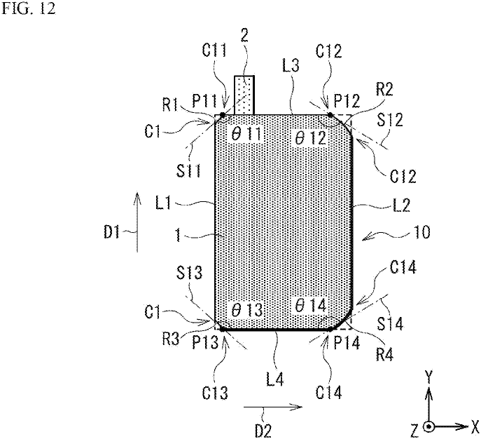

However, as illustrated in FIG. 12 corresponding to FIG. 1, a corner part C11 having a convex shape may be provided at the coupling portion of the linear end part L3 to the curved end part R1, and a corner part C12 having a convex shape may be provided at the coupling portion of the linear end part L3 to the curved end part R2.

The corner part C11 is a corner part having a vertex at the coupling portion (coupling point P11) between the curved end part R1 and the linear end part L3. The corner part C11 has an angle θ11. The angle θ11 is an angle defined by a straight line along the linear end part L3 and a tangent line S11 tangent to the curved end part R1 at the coupling point P11. The angle θ11 is an obtuse angle.

The corner part C12 is a corner part having a vertex at the coupling portion (coupling point P12) between the curved end part R2 and the linear end part L3. The corner part C12 has an angle θ12. The angle θ12 is an angle defined by a straight line along the linear end part L3 and a tangent line S12 tangent to the curved end part R2 at the coupling point P12. The angle θ12 is an obtuse angle.

As a matter of course, as illustrated in FIG. 12, a corner part C13 having a convex shape may be provided at the coupling portion of the linear end part L4 to the curved end part R3, and a corner part C14 having a convex shape may be provided at the coupling portion of the linear end part L4 to the curved end part R4.

The corner part C13 is a corner part having a vertex at the coupling portion (coupling point P13) between the curved end part R3 and the linear end part L4. The corner part C13 has an angle θ13. The angle θ13 is an angle defined by a straight line along the linear end part L4 and a tangent line S13 tangent to the curved end part R3 at the coupling point P13. The angle θ13 is an obtuse angle.

The corner part C14 is a corner part having a vertex at the coupling portion (coupling point P14) between the curved end part R4 and the linear end part L4. The corner part C14 has an angle θ14. The angle θ14 is an angle defined by a straight line along the linear end part L4 and a tangent line S14 tangent to the curved end part R4 at the coupling point P14. The angle θ14 is an obtuse angle.

The electrode 10 including the corner parts C11 to C14 is manufactured through the cutting processes (the pre-cutting process, the first cutting process, and the second cutting process) of the electrode precursor 20 using the cutting blades T1 and T2, as illustrated in FIG. 13 corresponding to FIGS. 4 to 7. Note that, in FIG. 13, in order to simplify the illustration, a portion of the electrode plate 21 to be cut by means of the cutting blade T1 and a portion of the electrode plate 21 to be cut by means of the cutting blade T2 are both indicated by respective broken lines.

In the first cutting process using the cutting blade T1, the cutting blade T1 is aligned with respect to the electrode precursor 20 such that the curved blade part X1 overlaps the linear end part L23 and that the curved blade part X2 overlaps the linear end part L24.

Further, in the second cutting process using the cutting blade T2, the cutting blade T2 is aligned with respect to the electrode precursor 20 such that the curved blade part Y1 overlaps the linear end part L23 and that the curved blade part Y2 overlaps the linear end part L24.

In this case also, the occurrence of a short circuit is suppressed, and the trade-off problem is eliminated. Similar effects are therefore obtainable.

In this case, even if the position of the cutting blade T1 (the curved blade parts X1 and X2) with respect to the electrode precursor 20 is shifted forward or backward in the direction D1 in, in particular, the first cutting process using the cutting blade T1, the corner parts C11 and C12 each having an obtuse angle are easily and stably formed. This suppresses formation of a burr that can cause the electrode 10 to break through the separator. This further improves safety.

The advantages described here in terms of the first cutting process using the cutting blade T1 are similarly obtainable also in the second cutting process using the cutting blade T2. That is, even if the position of the cutting blade T2 (curved blade parts Y1 and Y2) with respect to the electrode plate 21 is shifted forward or backward in the direction D1, formation of a burr is suppressed. This further improves the safety.

In the secondary battery illustrated in FIGS. 10 and 11, the positive electrode 41 has the configuration similar to the configuration of the electrode 10, whereas the negative electrode 42 has the configuration different from the configuration of the electrode 10.

However, the positive electrode 41 may have the configuration similar to the configuration of the electrode 10, and the negative electrode 42 may also have the configuration similar to the configuration of the electrode 10.

In this case also, the occurrence of a short circuit is suppressed, and the trade-off problem is eliminated, as compared with a case where the positive electrode 41 does not have the configuration similar to the configuration of the electrode 10 and where the negative electrode 42 does not have the configuration similar to the configuration of the electrode 10. Similar effects are therefore obtainable.

The secondary battery illustrated in FIG. 9 includes the separator 43 which is a porous film. However, although not specifically illustrated here, the secondary battery may include a separator of a stacked type including a polymer compound layer instead of the separator 43 which is the porous film.

For example, the separator of the stacked type includes a porous film having two opposed surfaces, and the polymer compound layer provided on one of or each of the two opposed surfaces of the porous film. A reason for this is that adherence of the separator to each of the positive electrode 41 and the negative electrode 42 improves to suppress the occurrence of misalignment (irregular winding) of the battery device 40. This helps to prevent the secondary battery from easily swelling even if, for example, a decomposition reaction of the electrolytic solution occurs. The polymer compound layer includes a polymer compound such as polyvinylidene difluoride. A reason for this is that the polymer compound such as polyvinylidene difluoride has superior physical strength and is electrochemically stable.

Note that the porous film, the polymer compound layer, or both may each include one or more kinds of insulating particles. A reason for this is that the insulating particles dissipate heat upon heat generation by the secondary battery, thus improving safety or heat resistance of the secondary battery. Examples of the insulating particles include inorganic particles and resin particles. Specific examples of the inorganic particles include particles of: aluminum oxide, aluminum nitride, boehmite, silicon oxide, titanium oxide, magnesium oxide, and zirconium oxide. Specific examples of the resin particles include particles of acrylic resin and particles of styrene resin.

In a case of fabricating the separator of the stacked type, a precursor solution including, without limitation, the polymer compound and a solvent is prepared, following which the precursor solution is applied on one of or each of the two opposed surfaces of the porous film. In this case, insulating particles may be added to the precursor solution on an as-needed basis.

In the case where the separator of the stacked type is used also, lithium ions are movable between the positive electrode 41 and the negative electrode 42, and similar effects are therefore obtainable.

The secondary battery illustrated in FIG. 9 includes the electrolytic solution which is a liquid electrolyte. However, although not specifically illustrated here, the secondary battery may include an electrolyte layer which is a gel electrolyte instead of the electrolytic solution.

In the battery device 40 including the electrolyte layer, the positive electrode 41 and the negative electrode 42 are stacked on each other with the separator 43 and the electrolyte layer interposed therebetween. The electrolyte layer is interposed between the positive electrode 41 and the separator 43, and between the negative electrode 42 and the separator 43.

For example, the electrolyte layer includes a polymer compound together with the electrolytic solution. The electrolytic solution is held by the polymer compound. A reason for this is that liquid leakage of the electrolytic solution is prevented. The configuration of the electrolytic solution is as described above. The polymer compound includes, for example, polyvinylidene difluoride. In a case of forming the electrolyte layer, a precursor solution including, for example, the electrolytic solution, the polymer compound, and the solvent is prepared, following which the precursor solution is applied on one side or both sides of the positive electrode 41 and one side or both sides of the negative electrode 42.

In a case where the electrolyte layer is used also, lithium ions are movable between the positive electrode 41 and the negative electrode 42 via the electrolyte layer, and similar effects are therefore obtainable.

Applications (application examples) of the battery are not particularly limited. A description is given below of applications of a secondary battery which is an example of the battery according to an embodiment.

The secondary battery used as a power source may serve as a main power source or an auxiliary power source of, for example, electronic equipment and an electric vehicle. The main power source is preferentially used regardless of the presence of any other power source. The auxiliary power source is used in place of the main power source, or is switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include home battery systems or industrial battery systems for accumulation of electric power for a situation such as emergency. In these applications, one secondary battery may be used, or multiple secondary batteries may be used.

The battery pack may include a single battery, or may include an assembled battery. The electric vehicle is a vehicle that operates (travels) using the secondary battery as a driving power source, and may be a hybrid automobile that is additionally provided with a driving source other than the secondary battery. In the electric power storage system for home use, electric power accumulated in the secondary battery which is an electric power storage source may be utilized for using, for example, home electric appliances.

Now, a description is given of an application example of the secondary battery according to an embodiment. A configuration of the application example described below is a mere example, and is appropriately modifiable.

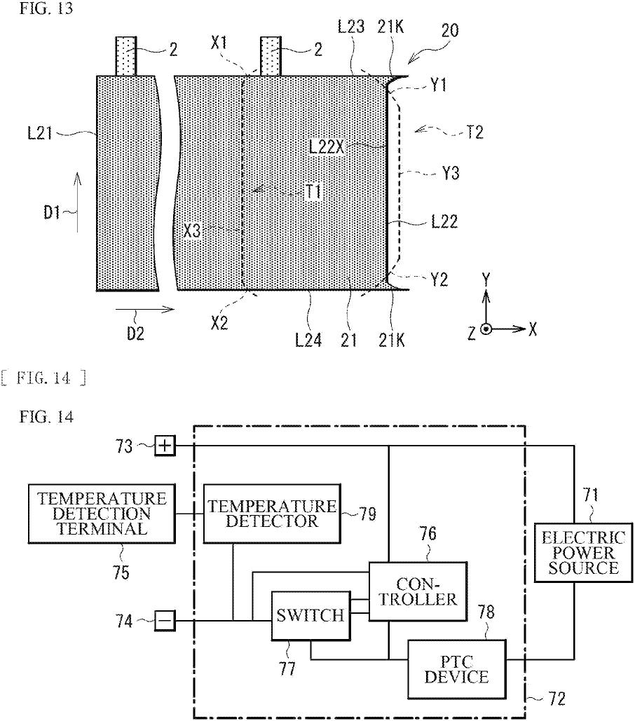

FIG. 14 illustrates a block configuration of a battery pack. The battery pack described here is a battery pack (a so-called soft pack) including one secondary battery, and is to be mounted on, for example, electronic equipment typified by a smartphone.

As illustrated in FIG. 14, the battery pack includes an electric power source 71 and a circuit board 72. The circuit board 72 is coupled to the electric power source 71, and includes a positive electrode terminal 73, a negative electrode terminal 74, and a temperature detection terminal 75.

The electric power source 71 includes one secondary battery. The secondary battery has a positive electrode lead coupled to the positive electrode terminal 73 and a negative electrode lead coupled to the negative electrode terminal 74. The electric power source 71 is couplable to outside via the positive electrode terminal 73 and the negative electrode terminal 74, and is thus chargeable and dischargeable. The circuit board 72 includes a controller 76, a switch 77, a thermosensitive resistive device (a PTC device) 78, and a temperature detector 79. However, the PTC device 78 may be omitted.

The controller 76 includes, for example, a central processing unit (CPU) and a memory, and controls an overall operation of the battery pack. The controller 76 detects and controls a use state of the electric power source 71 on an as-needed basis.

If a voltage of the electric power source 71 (the secondary battery) reaches an overcharge detection voltage or an overdischarge detection voltage, the controller 76 turns off the switch 77. This prevents a charging current from flowing into a current path of the electric power source 71. The overcharge detection voltage is not particularly limited, and is specifically 4.2 V ± 0.05 V. The overdischarge detection voltage is not particularly limited, and is specifically 2.4 V ± 0.1 V.

The switch 77 includes, for example, a charge control switch, a discharge control switch, a charging diode, and a discharging diode. The switch 77 performs switching between coupling and decoupling between the electric power source 71 and external equipment in accordance with an instruction from the controller 76. The switch 77 includes, for example, a metal-oxide-semiconductor field-effect transistor (MOSFET). The charging and discharging currents are detected based on an ON-resistance of the switch 77.

The temperature detector 79 includes a temperature detection device such as a thermistor. The temperature detector 79 measures a temperature of the electric power source 71 using the temperature detection terminal 75, and outputs a result of the temperature measurement to the controller 76. The result of the temperature measurement to be obtained by the temperature detector 79 is used, for example, in a case where the controller 76 performs charge/discharge control upon abnormal heat generation or in a case where the controller 76 performs a correction process upon calculating a remaining capacity.

Although the present technology has been described above with reference to one or more embodiments including Examples, the configuration of the present technology is not limited thereto, and is therefore modifiable in a variety of suitable ways.

The description has been given of the case where the secondary battery has a battery structure of the laminated-film type; however, the battery structure is not particularly limited in kind. For example, the battery structure may be, for example, of a cylindrical type, a prismatic type, a coin type, or a button type.

Further, the description has been given of the case where the battery device has a device structure of a stacked type; however, the device structure of the battery device is not particularly limited in kind. For example, the device structure may be, for example, of a zigzag folded type in which the electrodes are folded in a zigzag manner.

Further, the description has been given of the case where the electrode reactant is lithium; however, the electrode reactant is not particularly limited in kind. For example, the electrode reactant may be another alkali metal such as sodium or potassium, or may be an alkaline earth metal such as beryllium, magnesium, or calcium, as described above. Alternatively, the electrode reactant may be another light metal such as aluminum.

The effects described herein are mere examples, and effects of the present technology are therefore not limited to those described herein. Accordingly, the present technology may achieve other suitable effects.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1] An electrode for a battery, the electrode comprising:
an electrode body including a current collector and an active material layer provided on the current collector; and
an electrode tab coupled to the current collector and extending in a first direction, wherein
the electrode body includes
a first curved end part having a convex shape and disposed on a back side relative to the electrode tab in a second direction intersecting with the first direction,
a first noncurved end part coupled to the first curved end part and forming a first corner part at a coupling portion to the first curved end part, the first corner part having a convex shape toward the back side,
a second curved end part having a convex shape and disposed on a front side relative to the electrode tab in the second direction, and
a second noncurved end part coupled to the second curved end part and forming a second corner part at a coupling portion to the second curved end part, the second corner part having a convex shape toward the front side,
a curvature radius of the first curved end part and a curvature radius of the second curved end part are different from each other, and
an angle of the first corner part and an angle of the second corner part are each an obtuse angle.

2] The electrode for a battery according to claim 1, wherein
the curvature radius of the first curved end part is greater than or equal to 0.5 millimeters and less than or equal to 2.5 millimeters, and
the curvature radius of the second curved end part is greater than or equal to 1.0 millimeters and less than or equal to 5.0 millimeters.

3] The electrode for a battery according to claim 1, wherein
the electrode body further includes
a third curved end part having a convex shape and disposed on the back side relative to the electrode tab in the second direction, and
a fourth curved end part having a convex shape and disposed on the front side relative to the electrode tab in the second direction,
the first noncurved end part is coupled to the third curved end part and forms a third corner part at a coupling portion to the third curved end part, the third corner part having a convex shape toward the back side,
the second noncurved end part is coupled to the fourth curved end part and forms a fourth corner part at a coupling portion to the fourth curved end part, the fourth corner part having a convex shape toward the front side,
a curvature radius of the third curved end part and a curvature radius of the fourth curved end part are different from each other,
an angle of the third corner part and an angle of the fourth corner part are each an obtuse angle, and
the electrode body has a substantially quadrangular planar shape including the first curved end part, the second curved end part, the third curved end part, and the fourth curved end part at four respective corners.

4] A manufacturing method of an electrode for a battery, the manufacturing method comprising:
preparing an electrode precursor including an electrode plate and a plurality of electrode tabs coupled to the electrode plate, the electrode tabs each extending in a first direction, the electrode tabs being coupled to the electrode plate and being separated from each other in a second direction intersecting with the first direction;
cutting the electrode plate within a region including one of the electrode tabs of the electrode precursor at a position on a back side relative to the one electrode tab in the second direction by means of a first cutting blade; and
thereafter cutting the electrode plate cut by the first cutting blade at a position on a front side relative to the one electrode tab in the second direction by a second cutting blade, wherein
the electrode plate includes
a current collector to which the electrode tabs are coupled, and
an active material layer provided on the current collector,
the first cutting blade includes
a first curved blade part curved into a convex shape toward the back side, and
a noncurved blade part coupled to the first curved blade part and forming a blade corner part at a coupling portion to the first curved blade part, the blade corner part having a convex shape toward the back side,
the second cutting blade includes a second curved blade part at a position corresponding to the first curved blade part in the second direction, the second curved blade part being curved into a convex shape toward the front side,
a curvature radius of the second curved blade part is greater than a curvature radius of the first curved blade part,
an angle of the blade corner part is an obtuse angle, and
when the electrode plate is cut by means of the second cutting blade, the second cutting blade is aligned with respect to the electrode precursor to cause the second curved blade part to overlap a portion of the electrode plate cut by means of the noncurved blade part of the first cutting blade.

5] The manufacturing method of the electrode for a battery according to claim 4, wherein the cutting of the electrode plate by the first cutting blade and the cutting of the electrode plate by the second cutting blade are repeated for each region of the electrode precursor including one of the electrode tabs.

6] A battery comprising:
the electrode for a battery according to claim 1; and
an electrolytic solution.

7] The battery according to claim 6, wherein
the battery comprises a lithium-ion secondary battery including a positive electrode and a negative electrode, and
the electrode for a battery includes the positive electrode.

8] The battery according to claim 7, wherein
the negative electrode is opposed to an entirety of the positive electrode, and
the negative electrode has corner parts at respective positions corresponding to the first curved end part and the second curved end part, the corner parts each having a convex shape.
